(19) United States
(12) Patent Application Publication
(10) Pub. No.: US 2013/0325693 A1
(43) Pub. Date: Dec. 5, 2013

(54) CREDIT BEHAVIOR NETWORK MAPPING

(71) Applicant: Maria SINGSON, Califon, NJ (US)

(72) Inventor: Maria SINGSON, Califon, NJ (US)

(73) Assignee: THE DUN & BRADSTREET CORPORATION, Short Hills, NJ (US)

(21) Appl. No.: 13/483,754

(22) Filed: May 30, 2012

(51) Int. Cl. G06Q 40/02

(52) U.S. Cl. 705/38

(57) ABSTRACT

A method including receiving an identifier of a first entity, performing a first search of a database that returns an identifier of a second entity having a relationship with the first entity, performing a second search of a database that returns an identifier of a third entity that is a creditor of the second entity, and constructing in a storage device, a data structure that defines a path between the first entity and the third entity via the second entity. The method can be executed by an apparatus having a processor and a memory with instructions. The instructions, when read by the processor, cause the processor to perform the method described above.

### BACKGROUND OF THE DISCLOSURE

1. Field of the Disclosure

The present disclosure relates to credit evaluation, and more particularly, to a credit behavior network mapping procedure.

2. Description of the Related Art

The approaches described in this section are approaches that could be pursued, but not necessarily approaches that have been previously conceived or pursued. Therefore, unless otherwise indicated, the approaches described in this section may not be prior art to the claims in this application and are not admitted to be prior art by inclusion in this section.

Conventional techniques for credit worthiness or a credit score, such as a Fair Isaac Corporation (FICO) Credit Score, indicate a likelihood for a company to pay its current debt. Lenders, such as banks and credit card companies, use credit scores to evaluate potential risk posed by lending money to consumers. Widespread use of credit scores has made credit more widely available and cheaper for consumers.

FICO and other similar techniques, analyze a company's financial history to generate a credit score. For example, FICO analyzes the company's payment history, credit utilization, length of credit history, types of credit used, e.g., installment, revolving, consumer finance and mortgage, recent searches for credit, and special factors such as liens.

However, the FICO evaluation only analyzes a single company's financial history to generate a credit score. This limits the scope of the FICO evaluation and, further, fails to recognize and account for factors relating to a global supply chain.

Accordingly, a need remains for a broader and global evaluation of credit behavior for a company.

### SUMMARY OF THE DISCLOSURE

There is provided a credit behavior network mapping procedure that evaluates cash flow, i.e. accounts receivable for a business.

There is further provided a method including receiving an identifier of a first entity, performing a first search of a database that returns an identifier of a second entity having a relationship with the first entity, performing a second search of a database that returns an identifier of a third entity that is a creditor of the second entity, and constructing in a storage device, a data structure that defines a path between the first entity and the third entity via the second entity.

There is also provided a method including receiving an identifier of a first entity, performing a first search of a database that returns an identifier of a second entity that is a creditor of the first entity, performing a second search of a database that returns an identifier of a third entity that is a creditor of the second entity, and constructing in a storage device, a data structure that defines a path between the first entity and the third entity via the second entity.

There is further provided a method including receiving an identifier of a first entity, performing a first search of a database that returns an identifier of a second entity that is hierarchically related to the first entity, performing a second search of a database that returns an identifier of a third entity that is a creditor of the second entity, and constructing in a storage device, a data structure that defines a path between the first entity and the third entity via the second entity.

There is also provided a method including receiving an identifier of a first entity, performing a first search of a database that returns an identifier of a second entity that has made a credit inquiry about the first entity, performing a second search of a database that returns an identifier of a third entity that is a creditor of the second entity, and constructing in a storage device, a data structure that defines a path between the first entity and the third entity via the second entity.

There is further provided a method including receiving an identifier of a first entity; performing a first search of a database that returns an identifier of a second entity that is a creditor of the first entity; performing a second search of a database that returns an identifier of a third entity that has made a credit inquiry about the second entity; and constructing in a storage device, a data structure that defines a path between the first entity and the third entity via the second entity.

There is also provided a method including receiving an identifier of a first entity; performing a first search of a database that returns an identifier of a second entity that is hierarchically related to the first entity; performing a second search of a database that returns an identifier of a third entity that has made a credit inquiry about the second entity; and constructing in a storage device, a data structure that defines a path between the first entity and the third entity via the second entity.

There is further provided an apparatus for executing the above provided methods. The apparatus includes a processor and a memory. The memory contains instructions, that are readable by the processor, and, when read by the processor, cause the processor to perform the actions of the method steps described-above.

Further, there is a non-transitory storage medium that includes instructions that are readable by a processor. The instructions, when read by the processor, cause the processor to perform the actions of the methods provided above.

### BRIEF DESCRIPTION OF THE DRAWINGS

FIG. 1 illustrates a system for generating a credit behavior network map.

FIG. 2 illustrates one example of a financial relationship map.

FIG. 3 illustrates another financial relationship map.

FIG. 4 illustrates another example of a financial relationship map.

FIG. 5 is a method for evaluating a credit behavior of an entity.

FIG. 6 is a further method for evaluating the credit behavior of an entity.

FIG. 7 is a further method for evaluating the credit behavior of an entity.

FIG. 8 is a further method for evaluating the credit behavior of an entity.

FIG. 9 is a further method for evaluating the credit behavior of an entity.

A component or a feature that is common to more than one drawing is indicated with the same reference number in each of the drawings.

### DESCRIPTION OF THE DISCLOSURE

The present disclosure describes methods and systems to provide a forward looking credit network map that provides financial data for a company of interest via monitoring companies having varying degrees of separation thereto. This forward looking credit network map provides a financial model that can, for example, identify disruptions of credit at varying points of a credit supply chain and associate those disruptions to an ultimate affect on the operations of the company of interest.

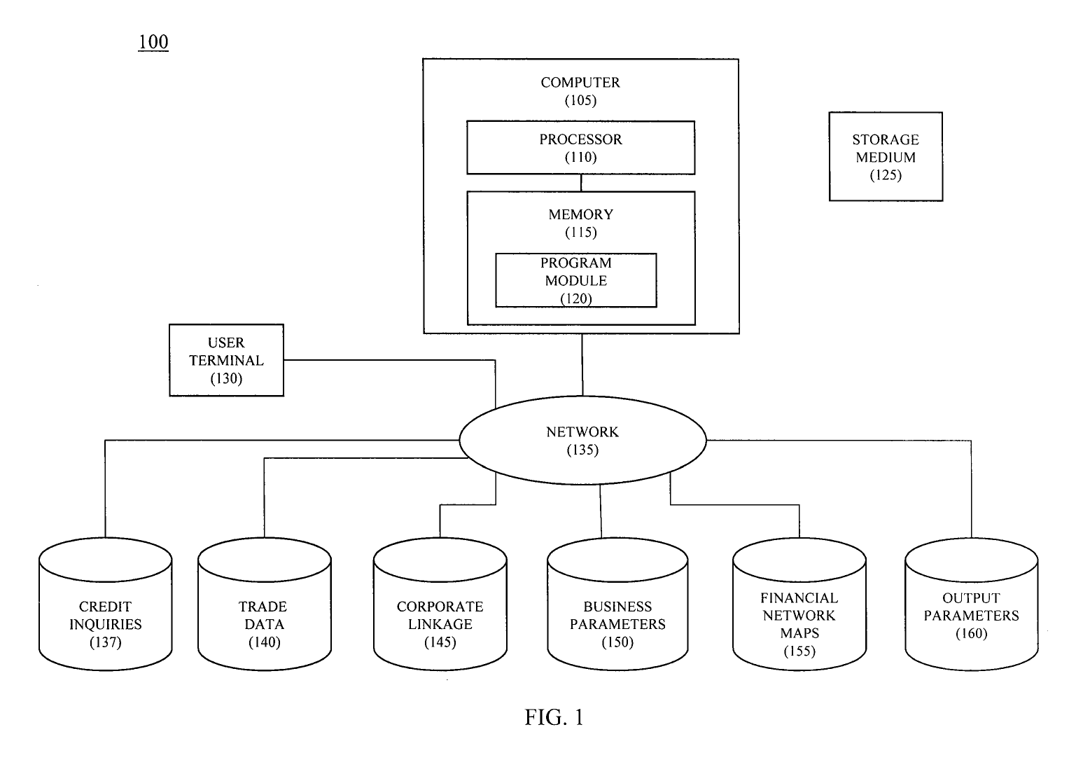

Referring to the figures, and in particular FIG. 1, there is provided a system 100 for generating a credit behavior network map. System 100 includes a computer 105 connected to a user terminal 130 and databases via a network 135.

The databases can be one or more physical databases. Collectively, the databases include credit inquiries 137, trade data 140, corporate linkage 145, business parameters 150, financial network maps 155, and output parameters 160.

Computer 105 includes a processor 110 in communication with a memory 115. Memory 115 includes a program module 120. Processor 110 is configured of logic circuitry that responds to and executes instructions. The term “module” is used herein to denote a functional operation that may be embodied either as a stand-alone component or as an integrated configuration of a plurality of sub-ordinate components.

Although system 100 is described herein as having the instructions for the method of the present disclosure installed into memory 115, the instructions can be tangibly embodied on an external computer-readable storage medium 125 for subsequent loading into memory 115. Storage medium 125 can be any conventional storage medium, including, but not limited to, a floppy disk, a compact disk, a magnetic tape, a read only memory, an optical storage medium, universal serial bus (USB) flash drive, a digital versatile disc, or a zip drive. The instructions could also be embodied in a random access memory, or other type of electronic storage, located on a remote storage system and coupled to memory 115.

Moreover, although program module 120, is described herein as being installed in memory 115, and therefore being implemented in software, it could be implemented in any of hardware (e.g., electronic circuitry), firmware, software, or a combination thereof.

Credit inquiries 137 typically stores data such as a request by a lending institution, a landlord or an employer that seeks to review a credit history for a company of interest. In addition credit inquiries 137 can include 3^{rd} party requests for credit history, e.g, perspective lenders. Credit inquiries 137 typically stores data indexed by the company for which the credit history is requested, e.g., the company of interest.

Trade data 140 includes financial data for companies, such as accounts receivable data. Accounts receivable data is information such as money owed to a particular company by the company's debtors. In addition, accounts receivable data identifies an entity as a debtor to a creditor and indicates an amount of the credit. Accounts receivable data is typically indexed according to creditor information and, specifically, includes account receivables for suppliers of a company of interest. Processor 110, under the instruction of program module 120, receives accounts receivable data from a company and populates trade data 140.

Corporate linkage 145 includes corporate relationship data for a company of interest. The corporate relationship data are hierarchical relationships between relatives of the company of interest and, further, between relatives of suppliers of the company of interest. For example, corporate linkage 145 includes hierarchical relationship identifiers such as a parent, a subsidiary, a branch, a business partner and relatives that are neither a parent nor subsidiary, e.g., companies having a common parent.

Business parameters 150 include bankruptcy data, firm demographics data, inquiry data and market cap data for a company. Bankruptcy data includes indicators for suppliers in bankruptcy. Firm demographics data includes company data such as: the number of employees, industry type and size. Inquiry data includes information about a company making an inquiry about the company of interest and, further, the quantity, e.g., a numerical value, of companies making inquiries about the company of interest. Market cap data includes market cap information of companies at various times, e.g., daily, weekly and monthly.

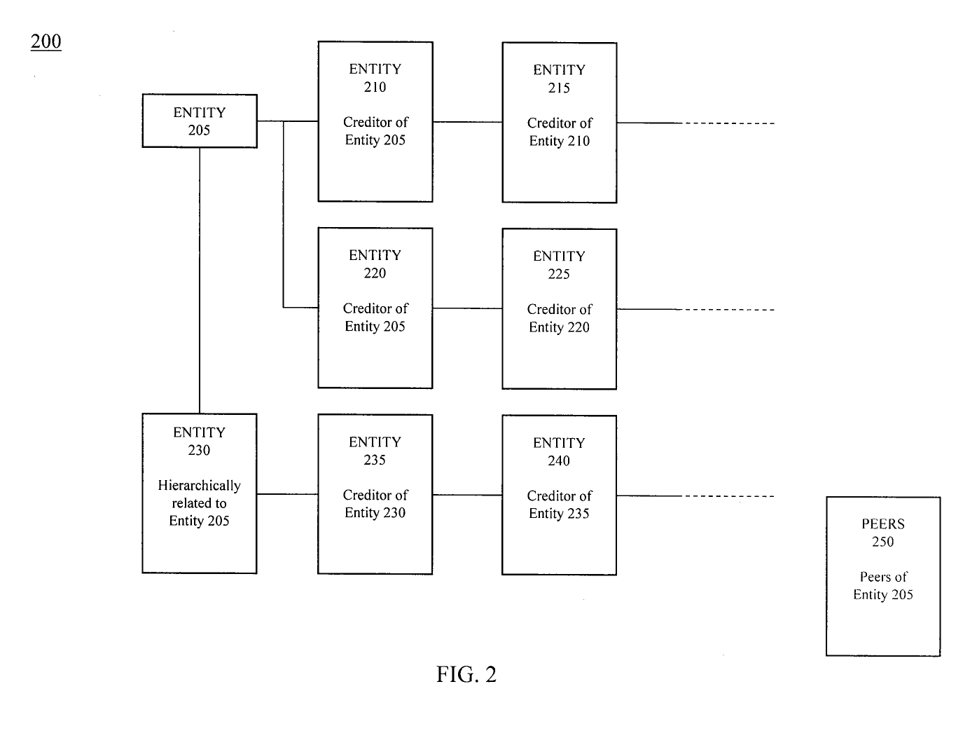

Financial network maps 155 include financial relationship maps for the company of interest and related companies separated by varying degrees of separation. Typically, the financial relationship maps represent cash flow signals and trends for suppliers and suppliers' suppliers related to the company of interest. Suppliers are companies that provide goods or services to the company of interest. Suppliers include utilities, temporary staffing agencies and office suppliers. In addition, the financial relationship maps can include companies that are hierarchically related and, further, suppliers and suppliers' suppliers for the hierarchically related companies. FIGS. 2 through 4, discussed below, are examples of financial relationship maps.

Output parameters 160 are the results of evaluations of an entity of interest. For example, output parameters 160 may include a change or delta in market cap of the entity of interest.

User terminal 130 is an input/output device that can receive input from a user and output results to the user. For example, user terminal 130 can include a keyboard or speech recognition subsystem, for enabling the user to communicate information and command selections to processor 110. User terminal 130 also includes output devices such as a display or a printer. A cursor control such as a mouse, track-ball, or joy stick, allows the user to manipulate a cursor on the display for communicating additional information and command selections to processor 110.

FIG. 2 is one example of a financial relationship map, e.g., a credit network map 200. Credit network map 200 illustrates a global supply chain, e.g., a supply of credit, in relation to a particular company of interest, i.e., entity 205. Credit network map 200 specifically illustrates companies sharing varying degrees of separation in relation to entity 205. Financial information provided by various points, e.g., companies, of the global supply chain of credit ultimately affects the financial health of entity 205, e.g., the credit risk of entity 205.

Companies within the global supply chain that share varying degrees of separation to entity 205 include companies such as creditors, hierarchically related companies, and industry peers. The financial health for each of these companies, in turn, can provide an early credit risk warning for entity 205.

Creditors of entity 205 include entity 210 and entity 220. Credit network map 200 also includes companies within the global supply chain, such as creditors' creditors. Entity 215 is a creditor of entity 210, entity 225 is a creditor of entity 220, and entity 240 is a creditor of entity 235. The dotted lines connected to each of entity 215, entity 225 and entity 240 represent and unlimited number of creditors' creditors within the global supply chain. That is, credit network map 200 can be extended to include any desired depth or width of related companies.

Companies having a hierarchical relationship to entity 205 include entity 230. This hierarchical relationship can include a parent relationship, a subsidiary relationship or a relative relationship that is neither a parent nor subsidiary. As illustrated, entity 230 is a subsidiary of entity 205.

In addition, credit network map 200 includes peers 250 that are peers of entity 205. Peers 250 are companies from the same industry as entity 205, and are summarized as a comparison group to entity 205.

Processor 110 executes instructions from program module 120 to yield financial network maps 155 such as credit network map 200.

For example, the instructions from program module 120 cause processor 110 to receive an identifier of a first entity, perform a first search of a database that returns an identifier of a second entity having a relationship with the first entity, and perform a second search of a database that returns an identifier of a third entity that is a creditor of the second entity. The instructions further cause processor 110 to construct, in a storage device, a data structure that defines a path between the first entity and the third entity via the second entity.

Referring to credit network map 200, the first entity can be entity 205, the second entity can be entity 210, and the third entity can be entity 215. The first search returns an identifier of entity 210, and the second search returns an identifier of entity 215, and, as mentioned above, entity 215, i.e., the third entity, is a creditor of entity 210, i.e., the second entity. The relationship between entity 210 and entity 205 is that entity 210 is a creditor of entity 205. Credit network map 200 further illustrates a data structure that defines a path between entity 205 and entity 215, via entity 210.

The instructions from program module 120 can further cause processor 110 to evaluate a characteristic, e.g., a credit risk, of the first entity, e.g., entity 205, as a function of a characteristic, e.g., cash flow, of the third entity, e.g., entity 215.

In addition, the first search can return a first amount of credit extended from the second entity, e.g., entity 210, to the first entity, e.g., entity 205, and the second search can return a second amount of credit extended from the third entity, e.g., entity 215, to the second entity, e.g., entity 210.

In further embodiments, the second entity can be hierarchically related to the first entity. For example, the second entity can be entity 230, i.e., a subsidiary of entity 205. Accordingly, when processor 110 performs the first search of the database and returns an identifier of the second entity, processor 110 returns the identifier of entity 230, and when processor 110 performs the second search of the database and returns an identifier of the third entity, the processor returns the identifier of entity 235.

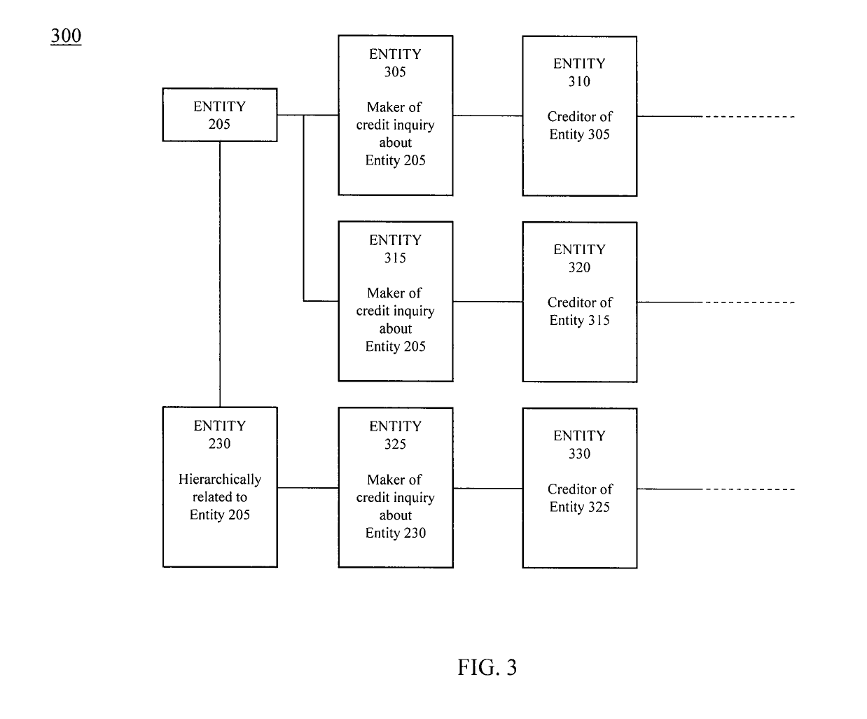

FIG. 3 illustrates another financial relationship map, e.g., a credit network map 300.

Credit network map 300 is another embodiment of a global financial chain in relation to entity 205. In particular, credit network map 300 further illustrates inquiring companies that demonstrate interest in entity 205 or entity 230 via credit inquiries, and, further, companies related to the inquiring companies, e.g., creditors of the inquiring company. In credit network map 300, an entity 305 is a maker of a credit inquiry about entity 205, and an entity 310 is a creditor of entity 305. An entity 315 is also a maker of a credit inquiry about entity 205, and an entity 320 is a creditor of entity 315. An entity 325 is a maker of a credit inquiry about entity 230, and an entity 330 is a creditor of entity 325.

Processor 110 executes instructions from program module 120 to yield financial network maps 155 such as credit network map 300. Instructions from program module 120 that cause processor 110 to yield credit network map 200, discussed above, are similarly employed to yield credit network map 300.

Specifically, the instructions cause processor 110 to receive an identifier of a first entity, perform a first search of a database that returns an identifier of a second entity having a relationship with the first entity, perform a second search of a database that returns an identifier of a third entity that is a creditor of the second entity, and construct in a storage device, a data structure that defines a path between the first entity and the third entity via the second entity. Further, the instructions can cause processor 110 to evaluate a characteristic of the first entity as a function of a characteristic of the third entity.

For example, the identifier of the first entity can be the identifier of entity 205. The first search returns an identifier of entity 305, e.g., the second entity having a relationship with the first entity. The relationship between entity 205 and entity 305 is that entity 305 is a maker of a credit inquiry about entity 205. The second search of the database returns the identifier of entity 310, e.g., the third entity that is a creditor of the second entity. In addition, the second search returns an amount of credit extended from entity 310 to entity 305. Credit network map 300 further illustrates a data structure that defines the path between entity 205, e.g., the first entity, and entity 310, e.g., the third entity, via entity 305, e.g., the second entity. Credit network map 300 can further include the identifier of entity 205, the identifier of entity 305, the identifier of entity 310, and the amount of credit extended from entity 310 to entity 305.

In further embodiments, instructions from program module 120 can cause processor 110 to receive an identifier of a first entity, perform a first search of a database that returns an identifier of a second entity that is hierarchically related to the first entity, perform a second search of a database that returns an identifier of a third entity that has made a credit inquiry about the second entity, and construct in a storage device, a data structure that defines a path between the first entity and the third entity, via the second entity. Further, the instructions can cause processor 110 to evaluate a characteristic about the first entity as a function of a characteristic of the third entity.

For example, the first entity is entity 205 and the second entity is 230. Entity 230 is hierarchically related to entity 205 since entity 230 is a subsidiary of entity 205. The second search can return the identifier of the entity 325 since entity 325 made a credit inquiry about entity 230. Credit network map 300 illustrates the data structure that defines a path between entity 205, e.g., the first entity, and entity 325, e.g., the third entity, via entity 230, e.g., the second entity. Further, the characteristic can be the credit risk of entity 205 as a function of a characteristic of entity 325.

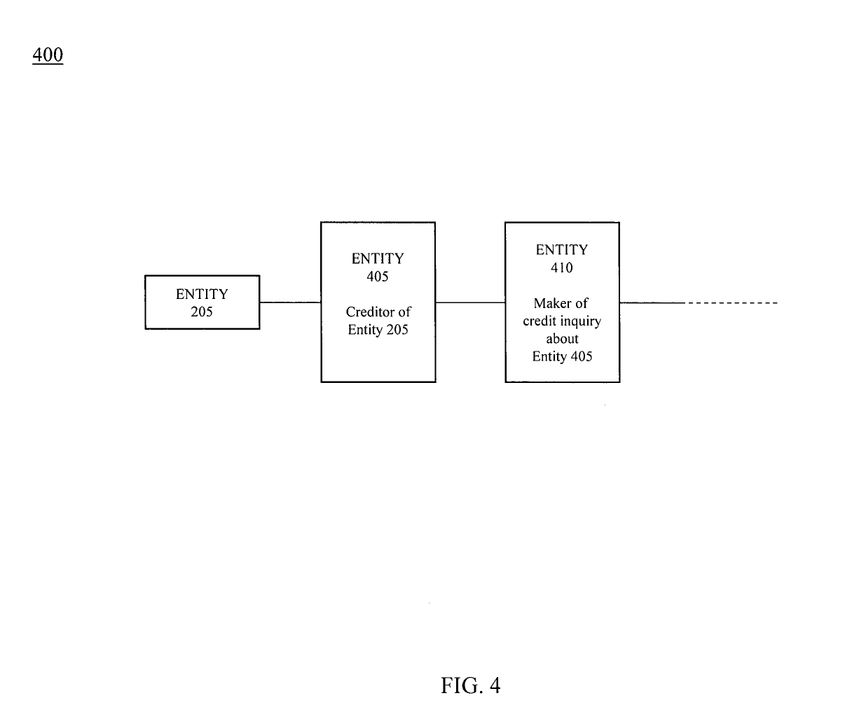

FIG. 4 is another example of a financial relationship map, e.g., a credit network map 400.

Credit network map 400 illustrates a global supply chain, e.g., a supply of credit, in relation to a particular company of interest, i.e., entity 205. Credit network map 400 specifically illustrates companies sharing varying degrees of separation in relation to entity 205 such as entity 405 and entity 410. Entity 405 is a creditor of entity 205 and entity 410 is a maker of credit inquiry about entity 405.

Processor 110 executes instructions from program module 120 to yield credit network map 400.

In particular, the instructions cause processor 110 to receive an identifier of a first entity, perform a first search of a database that returns an identifier of a second entity that is a creditor of the first entity, perform a second search of a database that returns an identifier of a third entity that has made a credit inquiry about the second entity, and construct in a storage device, a data structure that defines a path between the first entity and the third entity via the second entity.

For example, referring to FIG. 4, the identifier of the first entity can be entity 205. The first search returns an identifier of entity 405, e.g., a creditor of the first entity. The second search returns the identifier of entity 410, e.g., a third entity that has made a credit inquiry about entity 405 (the second entity). Moreover, FIG. 4 illustrates the data structure, constructed in a storage device, that defines the path between entity 205 and entity 410 via connecting lines.

In further embodiments, the instructions can further cause processor 110 to evaluate a characteristic of the first entity as a function of a characteristic of the third entity. In addition, the first search can also return a first amount of credit extended from the second entity to the first entity, and when the processor constructs the data structure, the processor can further include the identifier of the first entity, the identifier of the second entity, the identifier of the third entity and the amount of credit.

For example, processor 110 can evaluate the characteristic of credit risk of entity 205, i.e., the first entity, as function of the credit risk of entity 410, i.e., the third entity.

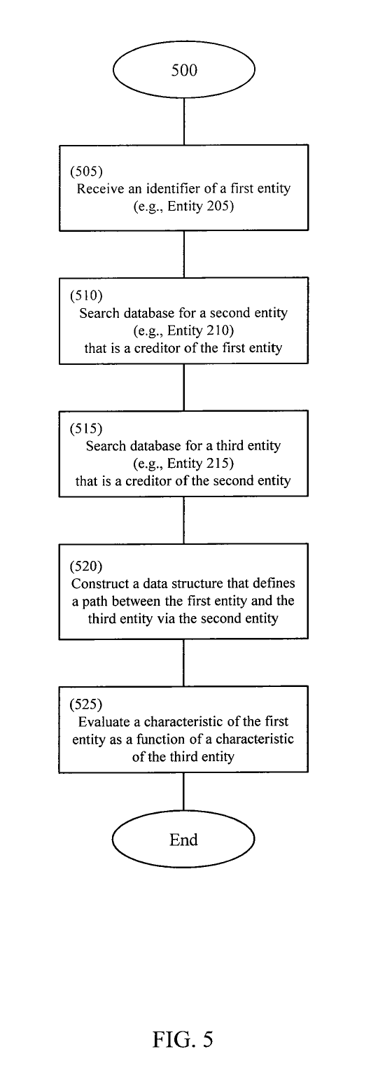

FIG. 5 is a method, i.e., method 500, for evaluating a credit behavior of an entity.

In particular, method 500 refers to a relationship between entities illustrated in financial relationship map 200 of FIG. 2. Specifically, method 500 refers to the relationship between entity 205, entity 210 and entity 215. Entity 210 is a creditor of entity 205, and entity 215 is a creditor of entity 210.

Method 500 begins with step 505. Step 505 provides for receiving an identifier of a first entity, e.g., entity 205. After step 505, method 500 progresses to step 510.

Step 510 provides for searching a database for a second entity, e.g., entity 210, that is a creditor of the first entity. After step 510, method 500 progresses to step 515.

Step 515 provides for searching a database for a third entity, e.g., entity 215, that is a creditor of the second entity. After step 515, method 500 progresses to step 520.

Step 520 provides for constructing a data structure that defines a path between the first entity and the third entity, via the second entity. After step 510, method 500 progresses to step 525.

Step 525 provides for evaluating a characteristic of the first entity as a function of a characteristic of the third entity. After step 525, method 500 ends.

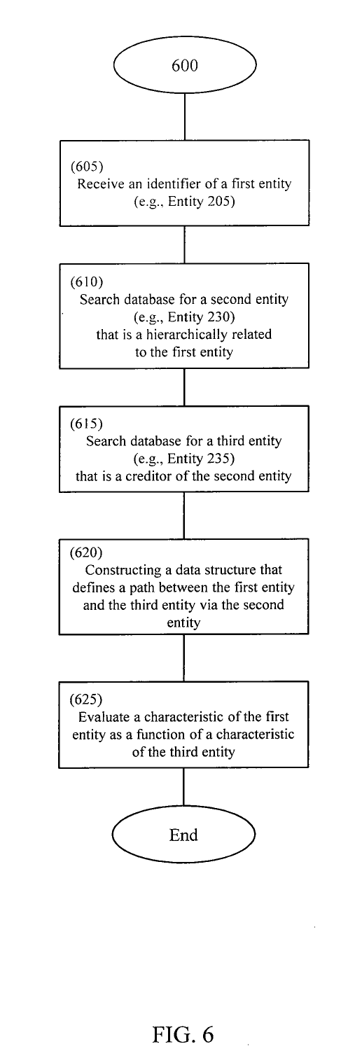

FIG. 6 is a further method, i.e., method 600, for evaluating the credit behavior of an entity.

In particular, method 600 refers to a relationship between entities illustrated in financial relationship map 200 of FIG. 2. Specifically, method 600 refers to the relationship between entity 205, entity 230 and entity 235. Entity 230 is hierarchically related to entity 205, and entity 235 is a creditor of entity 230.

Method 600 begins with step 605. Step 605 provides for receiving an identifier of a first entity, e.g., entity 205. After step 605, method 600 progresses to step 610.

Step 610 provides for searching a database for a second entity, e.g., entity 230, that is hierarchically related to the first entity. After step 610, method 600 progresses to step 615.

Step 615 provides for searching a database for a third entity, e.g., entity 235, which is a creditor of the second entity. After step 615, method 600 progresses to step 620.

Step 620 provides for constructing a data structure that defines a path between the first entity and the third entity via the second entity. After step 620, method 600 progresses to step 625.

Step 625 provides for evaluating a characteristic of the first entity as a function of a characteristic of the third entity. After step 625, method 600 ends.

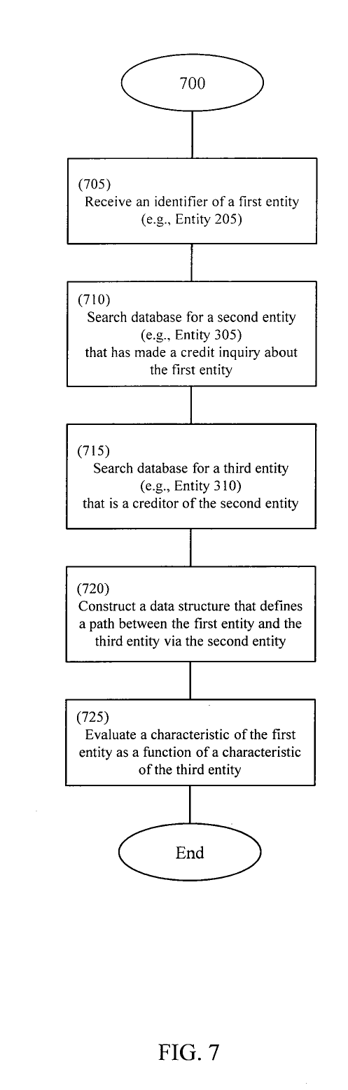

FIG. 7 is a further method for evaluating the credit behavior of an entity.

In particular, method 700 refers to a relationship between entities illustrated in financial relationship map 300 of FIG. 3. Specifically, method 700 refers to the relationship between entity 205, entity 305 and entity 310. Entity 305 is a maker of a credit inquiry about entity 205, and entity 310 is a creditor of entity 305.

Method 700 begins with step 705. Step 705 provides for receiving an identifier of a first entity, e.g., entity 205. After step 705, method 700 progresses to step 710.

Step 710 provides for searching a database for a second entity, e.g., entity 305, that has made a credit inquiry about the first entity. After step 710, method 700 progresses to step 715.

Step 715 provides for searching a database for a third entity, e.g., entity 310, that is a creditor of the second entity. After step 715, method 700 progresses to step 720.

Step 720 provides for constructing a data structure that defines a path between the first entity and the third entity, via the second entity. After step 720, method 700 progresses to step 725.

Step 725 provides for evaluating a characteristic of the first entity as a function of a characteristic of the third entity. After step 725, method 700 ends.

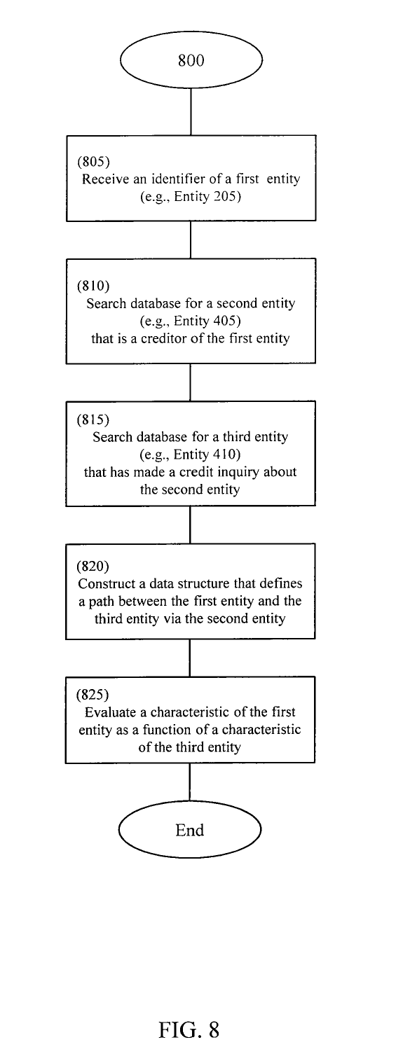

FIG. 8 is a further method for evaluating the credit behavior of an entity.

In particular, method 800 refers to a relationship between entities illustrated in financial relationship map 400 of FIG. 4. Specifically, method 800 refers to the relationship between entity 205, entity 405 and entity 410. Entity 405 is a creditor of entity 205, and entity 410 is a maker of a credit inquiry about entity 405.

Method 800 begins with step 805. Step 800 provides for receiving an identifier of a first entity, e.g., entity 205. After step 805, method 800 progresses to step 810.

Step 810 provides for searching a database for a second entity, e.g., entity 405, that is a creditor of the first entity. After step 810, method 800 progresses to step 815.

Step 815 provides for searching a database for a third entity, e.g., entity 410, that has made a credit inquiry about the second entity. After step 815, method 800 progresses to step 820.

Step 820 provides for constructing a data structure that defines a path between the first entity and the third entity, via the second entity. After step 820, method 800 progresses to step 825.

Step 825 provides for evaluating a characteristic of the first entity as a function of a characteristic of the third entity. After step 825, method 800 ends.

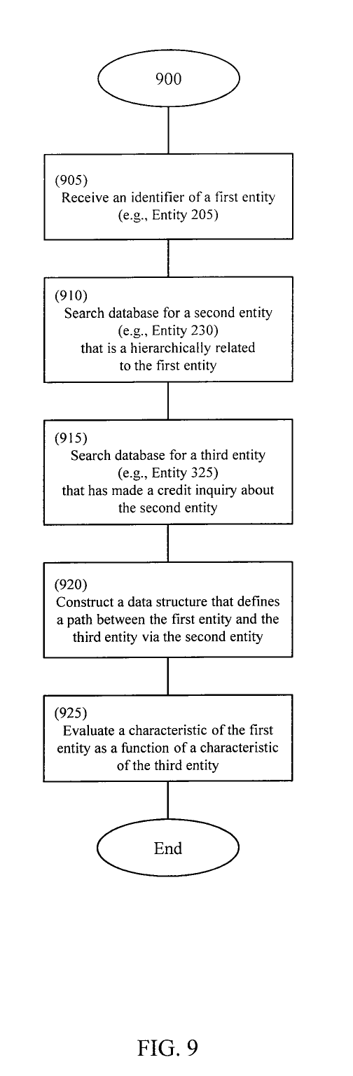

FIG. 9 is a further method for evaluating the credit behavior of an entity.

In particular, method 900 refers to a relationship between entities illustrated in financial relationship map 300 of FIG. 3. Specifically, method 900 refers to the relationship between entity 205, entity 230 and entity 325. Entity 230 is hierarchically related to entity 205, and entity 325 is a maker of a credit inquiry about entity 230.

Method 900 begins with step 905. Step 905 provides for receiving an identifier of a first entity, e.g., entity 205. After step 905, method 900 progresses to step 910.

Step 910 provides for searching a database for a second entity, e.g., entity 230, that is hierarchically related to the first entity. After step 910, method 900 progresses to step 915.

Step 915 provides for searching a database for a third entity, e.g., entity 325, that has made a credit inquiry about the second entity. After step 915, method 900 progresses to step 920.

Step 920 provides for constructing a data structure that defines a path between the first entity and the third entity, via the second entity. After step 920, method 900 progresses to step 925.

Step 925 provides for evaluating a characteristic of the first entity as a function of a characteristic of the third entity. After step 925, method 900 ends.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

1. A method performed by a processor in accordance with instructions that said processor read from a memory, comprising:
receiving an identifier of a first entity;
performing a first search of a database that returns an identifier of a second entity having a relationship with said first entity;
performing a second search of a database that returns an identifier of a third entity that is a creditor of said second entity; and
constructing in a storage device, a data structure that defines a path between said first entity and said third entity via said second entity.

2. The method of claim 1, further comprising:
evaluating a characteristic of said first entity as a function of a characteristic of said third entity.

3. The method of claim 1,
wherein said relationship is that said second entity is a creditor of said first entity,
wherein said first search also returns a first amount of credit being extended from said second entity to said first entity,
wherein said second search also returns a second amount of credit being extended from said third entity to said second entity, and
wherein said constructing includes in said data structure, (a) said identifier of said first entity, (b) said identifier of said second entity, (c) said identifier of said third entity, (d) said first amount of credit, and (e) said second amount of credit.

4. The method of claim 1,
wherein said relationship is that said second entity is hierarchically related to said first entity,
wherein said second search also returns an amount of credit being extended from said third entity to said second entity, and
wherein said constructing includes in said data structure, (a) said identifier of said first entity, (b) said identifier of said second entity, (c) said identifier of said third entity, and (d) said amount of credit.

5. The method of claim 1,
wherein said relationship is that said second entity has made a credit inquiry about said first entity,
wherein said second search also returns an amount of credit being extended from said third entity to said second entity, and
wherein said constructing includes in said data structure, (a) said identifier of said first entity, (b) said identifier of said second entity, (c) said identifier of said third entity, and (d) said amount of credit.

6-20. (canceled)

21. An apparatus comprising:
a processor; and
a memory that contains instructions that are readable by said processor, and that when read by said processor cause said processor to perform actions of:
receiving an identifier of a first entity;
performing a first search of a database that returns an identifier of a second entity having a relationship with said first entity;
performing a second search of a database that returns an identifier of a third entity that is a creditor of said second entity; and
constructing in a storage device, a data structure that defines a path between said first entity and said third entity via said second entity.

22. The apparatus of claim 21, wherein said instructions also cause said processor to perform an action of:
evaluating a characteristic of said first entity as a function of a characteristic of said third entity.

23. The apparatus of claim 21,
wherein said relationship is that said second entity is a creditor of said first entity,
wherein said first search also returns a first amount of credit being extended from said second entity to said first entity,
wherein said second search also returns a second amount of credit being extended from said third entity to said second entity, and
wherein said constructing includes in said data structure, (a) said identifier of said first entity, (b) said identifier of said second entity, (c) said identifier of said third entity, (d) said first amount of credit, and (e) said second amount of credit.

24. The apparatus of claim 21,
wherein said relationship is that said second entity is hierarchically related to said first entity,
wherein said second search also returns an amount of credit being extended from said third entity to said second entity, and
wherein said constructing includes in said data structure, (a) said identifier of said first entity, (b) said identifier of said second entity, (c) said identifier of said third entity, and (d) said amount of credit.

25. The apparatus of claim 21,
wherein said relationship is that said second entity has made a credit inquiry about said first entity,
wherein said second search also returns an amount of credit being extended from said third entity to said second entity, and
wherein said constructing includes in said data structure, (a) said identifier of said first entity, (b) said identifier of said second entity, (c) said identifier of said third entity, and (d) said amount of credit.

26-40. (canceled)

41. A non-transitory storage medium comprising instructions that are readable by a processor, and that when read by said processor cause said processor to perform actions of:
receiving an identifier of a first entity;
performing a first search of a database that returns an identifier of a second entity having a relationship with said first entity;
performing a second search of a database that returns an identifier of a third entity that is a creditor of said second entity; and
constructing in a storage device, a data structure that defines a path between said first entity and said third entity via said second entity.

42. The non-transitory storage medium of claim 41, wherein said instructions also cause said processor to perform an action of:
evaluating a characteristic of said first entity as a function of a characteristic of said third entity.

43. The non-transitory storage medium of claim 41,
wherein said relationship is that said second entity is a creditor of said first entity,
wherein said first search also returns a first amount of credit being extended from said second entity to said first entity,
wherein said second search also returns a second amount of credit being extended from said third entity to said second entity, and
wherein said constructing includes in said data structure, (a) said identifier of said first entity, (b) said identifier of said second entity, (c) said identifier of said third entity, (d) said first amount of credit, and (e) said second amount of credit.

44. The non-transitory storage medium of claim 41,
wherein said relationship is that said second entity is hierarchically related to said first entity,
wherein said second search also returns an amount of credit being extended from said third entity to said second entity, and
wherein said constructing includes in said data structure, (a) said identifier of said first entity, (b) said identifier of said second entity, (c) said identifier of said third entity, and (d) said amount of credit.

45. The non-transitory storage medium of claim 41,
wherein said relationship is that said second entity has made a credit inquiry about said first entity,
wherein said second search also returns an amount of credit being extended from said third entity to said second entity, and
wherein said constructing includes in said data structure, (a) said identifier of said first entity, (b) said identifier of said second entity, (c) said identifier of said third entity, and (d) said amount of credit.

46-60. (canceled)

61. The method of claim 1, wherein said data structure represents a credit risk of said first entity, as a function of a characteristic of said third entity.

62. The method of claim 1, wherein said data structure is representative of financial relationship maps indicative of cash flow signals and trends for suppliers and suppliers' suppliers of a company of interest.

63. The apparatus of claim 21, wherein said data structure represents a credit risk of said first entity, as a function of a characteristic of said third entity.

64. The apparatus of claim 21, wherein said data structure is representative of financial relationship maps indicative of cash flow signals and trends for suppliers and suppliers' suppliers of a company of interest.

65. The non-transitory storage medium 41, wherein said data structure represents a credit risk of said first entity, as a function of a characteristic of said third entity.

66. The non-transitory storage medium 41, wherein said data structure is representative of financial relationship maps indicative of cash flow signals and trends for suppliers and suppliers' suppliers of a company of interest.
